(19) United States
(12) Patent Application Publication
(10) Pub. No.: US 2016/0224736 A1
(43) Pub. Date: Aug. 4, 2016

(54) PORTABLE HEALTHCARE INFORMATION READABLE DEVICE AND METHODS OF USING SUCH A DEVICE

(71) Applicant: Upendra Patel, Lutz, FL (US)

(72) Inventor: Upendra Patel, Lutz, FL (US)

(21) Appl. No.: 15/012,338

(22) Filed: Feb. 1, 2016

Related U.S. Application Data
(60) Provisional application No. 62/110,844, filed on Feb. 2, 2015.

(51) Int. Cl. G06F 19/00; G06K 7/10

(52) U.S. Cl. CPC G06F 19/322; G06K 7/10881

(57) ABSTRACT

A portable device is provided for retrieving medical information pertaining to a selected patient. The device includes a readable tag configured to be read by at least one reader associated with a user interface. The user interface is configured to display the medical information upon the reader reading the tag.

### CROSS REFERENCE TO RELATED APPLICATION

This application claims the benefit of U.S. Provisional Patent Application No. 62/110,844, filed Feb. 2, 2015, which is incorporated herein by reference as if fully set forth.

### FIELD OF INVENTION

The invention relates generally to portable and readable devices for information retrieval. More specifically, the invention relates to portable and readable devices for retrieval of healthcare information by patients and medical treatment providers.

### BACKGROUND

In the field of healthcare, a patient's ability to accurately convey information to healthcare providers and individuals working with healthcare providers is critical. The process of conveying such information can be burdensome, due to patients' detailed medical histories, the need to accurately and completely recollect such information, and the number of healthcare providers that this information must be conveyed to. Patients often have to spend a substantial amount of time filling out healthcare questionnaires and responding to healthcare provider questions before treatment. Additionally, in emergency situations, there is often not a sufficient amount of time for healthcare providers to collect all needed information. Lacking or inaccurate information can often be detrimental to the patient's medical treatment.

A need exists for a quick and accurate way for patient medical data to be retrieved by patients and healthcare providers.

### SUMMARY

The invention relates to a portable device for retrieving medical information pertaining to a selected patient. The device includes a readable tag configured to be read by at least one reader associated with a user interface. The user interface is configured to display the medical information upon the reader reading the tag.

The invention further relates to an assembly for retrieving medical information pertaining to a selected patient. The assembly includes a portable device having a readable tag, a reader configured to read the tag, and user interface in communication with the reader. The user includes a visual interface configured to display the medical information upon the reader reading the tag.

The invention further relates to a method for retrieving medical information pertaining to a selected patient. The method includes providing at a device associated with the patient, the device including a readable tag. The method further includes providing a reader configured to read the tag, and providing a user interface associated with the reader. The user interface includes a visual interface and is configured to transmit a signal to a remote server that stores the medical information. The method further includes reading the tag with the reader, and transmitting the signal from the user interface to the remote server in response to reading the tag. The signal includes a request for the medical information. The signal is received by the server, and the medical information transmitted from the server to the user interface in response to the signal. The medical information is displayed on the visual interface.

### BRIEF DESCRIPTION OF THE DRAWINGS

FIG. 1 is a top plan view of an embodiment of a portable healthcare information readable device according to the invention, wherein the device is a carryable card.

FIG. 1A is a top plan view of another embodiment of a portable healthcare information readable device, similar to that of FIG. 1.

FIG. 2 is a bottom plan view of the device of FIG. 1.

FIG. 3 is a top view of another embodiment of a device according to the invention, wherein the device is a wearable sticker or badge.

FIG. 4 is a perspective view of another embodiment of a device according to the invention, wherein the device is a ring.

FIG. 5 is a perspective view of another embodiment of a device according to the invention, wherein the device is a keychain.

FIG. 6 is top view of another embodiment of a device according to the invention, wherein the device is a necklace pendant.

FIG. 7 is a schematic illustration showing a device, reader and user interface according to the invention.

FIG. 8 is a top plan view of a near field communication enabled smart phone in communication with a device according to the invention.

FIG. 9 is a top plan view of a non-near field communication enabled smart phone in communication with a remotely located reader according to the invention.

FIG. 10 is a schematic illustration showing transmission of detailed patient information from a remote server.

FIG. 11 is a flow chart illustrating an emergency reporting process using a phone or an interactive voice response enabled user interface.

FIG. 12 is a flow chart illustrating an emergency reporting process using a phone or a non-interactive voice response enabled user interface.

FIG. 13 is a flow chart illustrating an emergency reporting process using a hand held user interface.

FIG. 14 is a flow chart illustrating a login procedure for accessing detailed patient information.

FIG. 15 is a flow chart illustrating a procedure for accessing detailed patient information using a device with a locking feature.

FIG. 16 is a flow chart illustrating the procedure for providing different types of users with different subsets of detailed patient information based on the user's login credentials.

FIG. 17 illustrates an exemplary display on a visual interface, allowing for input of information to access detailed patient information in an emergency situation.

FIG. 18 illustrates another embodiment of a display on a visual interface, allowing for activation of an emergency button to access a subset of detailed patient information in an emergency situation.

### DETAILED DESCRIPTION OF THE PREFERRED EMBODIMENTS

Certain terminology is used in the foregoing description for convenience and is not intended to be limiting. Words such as “front,” “back,” “top,” and “bottom” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

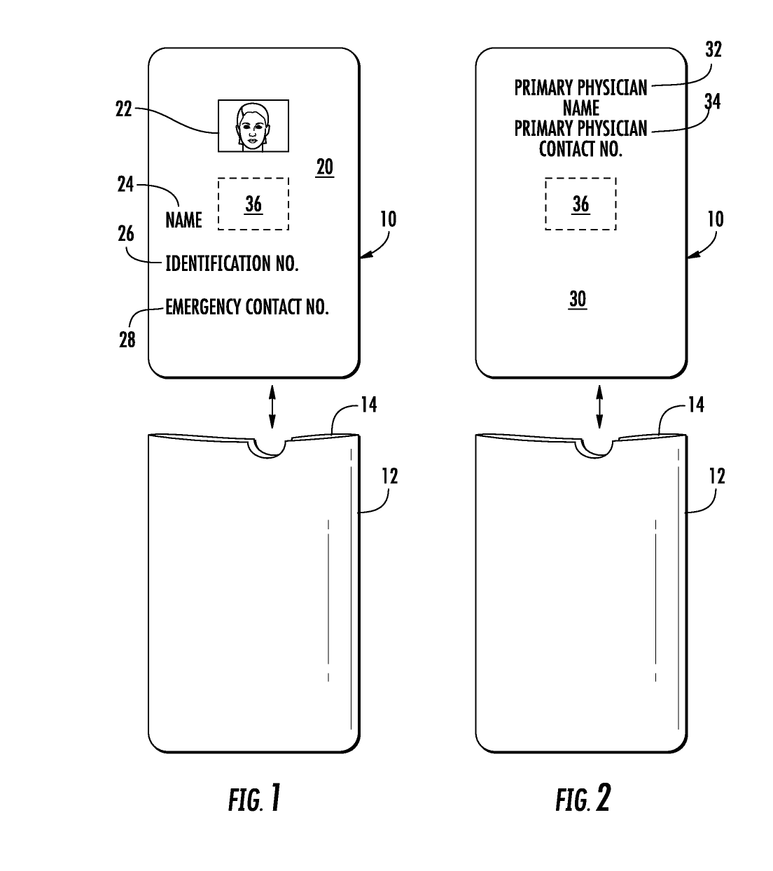

FIGS. 1 and 2 show a first embodiment of a device 10 according to the invention. In the embodiment shown, the device 10 is in the form of a carryable card, which may, for example, be shaped and sized similarly to a drivers' license or credit card, for example having a width of 3.370 inches and a height of 2.125 inches, however, a card having any dimensions that permit it to be conveniently carried on the person of a patient should be considered within the scope of the invention.

As shown in FIG. 1, the card 10 has a top surface 20 which may have information printed thereon. In the embodiment shown, such information includes a photographic image 22 of the patient, the patient's name 24, a unique patient identification number 26 and an emergency contact phone number 28. As used herein, “identification number” may be any type of code or designation, alpha numeric or otherwise, unique to the patient and which may associate a particular device 10 with a particular patient. As shown in FIG. 2, the card 10 includes a bottom surface 30 which may optionally have additional information printed thereon. In the illustrated embodiment, such printed information includes the name 32 and phone number 34 of the patient's primary care physician. FIGS. 17-20 show the top and bottom surfaces of an exemplary card 10 according to the invention. As shown, the card 10 may be provided with a carrying sleeve 12. In the illustrated embodiment, the sleeve 12 is of a substantially rectangular shape, similar to that of the card 10, but large enough to receive the card 10 through opening 14. The card 10 may be housed within the carrying sleeve 12 when not in use. In other embodiments, the card 10 could be provided without a sleeve 12.

The device 10 further includes a readable tag 36, which is embedded between the top surface 20 and bottom surface 30 in the embodiment shown. The tag 36 is near field communication (NFC) tag 36 in the embodiment shown. In another embodiment, shown in FIG. 1A, the tag 36A comprises a readable Quick Response (QR) code, which may be printed on the top surface 20, as shown, or bottom surface 30 of the card 10. In another embodiment, the device may include both a NFC tag 36, as shown in FIGS. 1 and 2, and a QR code, as shown in FIG. 1A.

In other embodiments, any of the information printed on the top surface 20 or bottom surface 30 could be printed on the other of the top surface 20 or bottom surface 30. In other embodiments, any or all of the information printed on the top surface 20 or bottom surface 30 could be omitted. In one embodiment, the card 10 is provided without any information printed thereon.

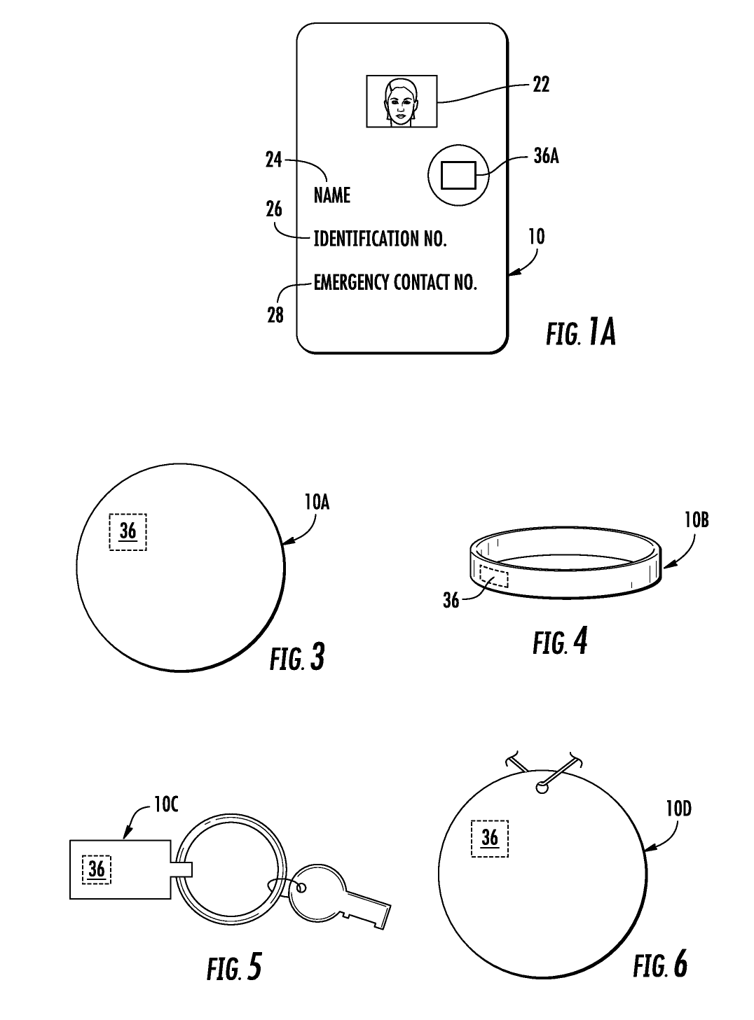

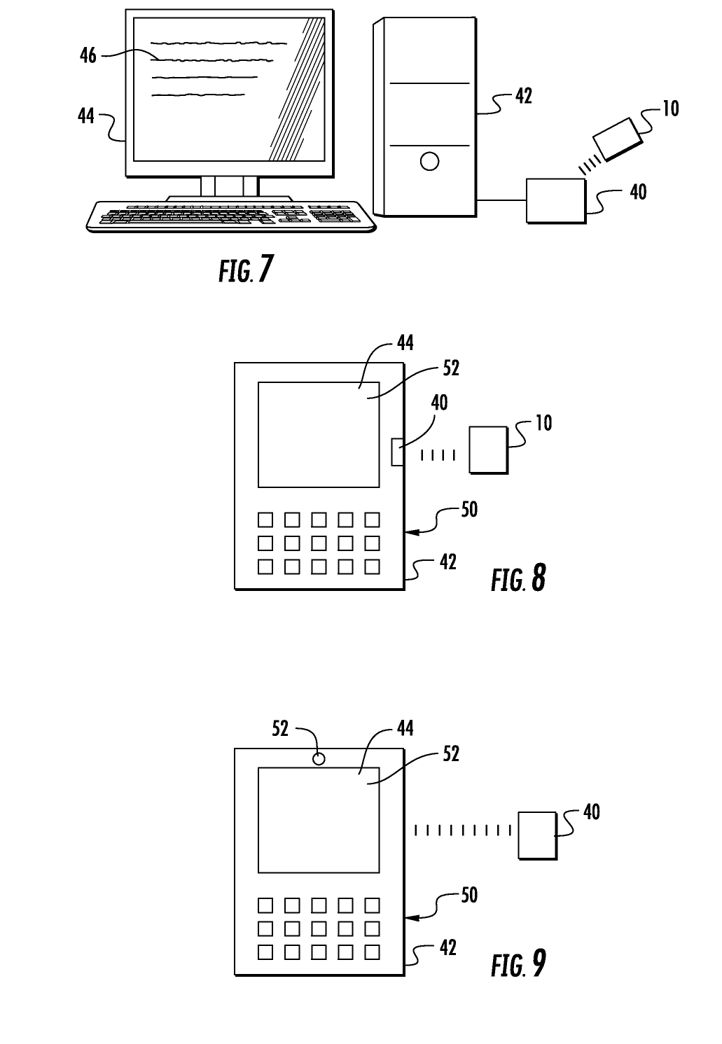

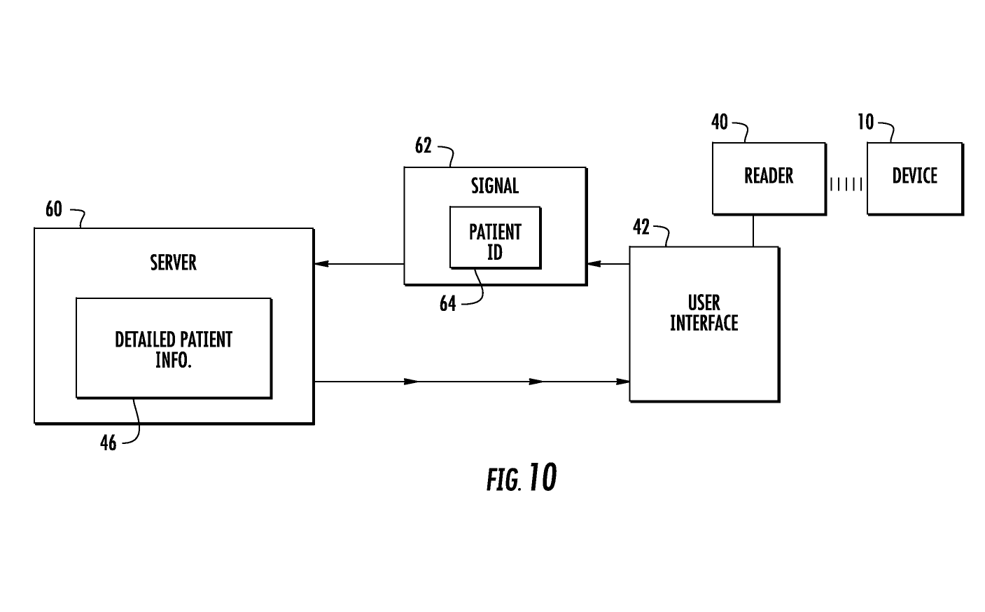

The invention is not restricted to the form of a card 10. FIGS. 3-6 illustrate other forms the device 10 according to the invention. FIG. 3 illustrates an embodiment in which the device 10A is in the form of a sticker or badge, FIG. 4 illustrates an embodiment in which the device 10B is a ring, FIG. 5 illustrates an embodiment in which the device 10C is a keychain, and FIG. 6 illustrates an embodiment in which the device 10D is a necklace pendant. The device 10 according to the invention may take on any of these forms, or any other conveniently carryable or wearable form. Each embodiment of the device 10 according to the invention includes a readable tag 36 and may include any of the information described above, including a photographic image 22 of the patient, the patient's name 24, a unique patient identification number 26, an emergency contact number 28, or other emergency contact information, primary care physician name 32 and primary care physician phone number 34.

The tag 36 is configured to be read by a reader 40. In embodiments in which the tag 36 is an NFC tag, the reader 40 is adapted to read NFC tags. In embodiments in which the tag 36 comprises a QR code, the reader is adapted to read QR codes. The reader 40 is in communication with a user interface 42 which comprises at least one visual interface 44. In some embodiments, the device 10 may include both an NFC tag and a QR code.

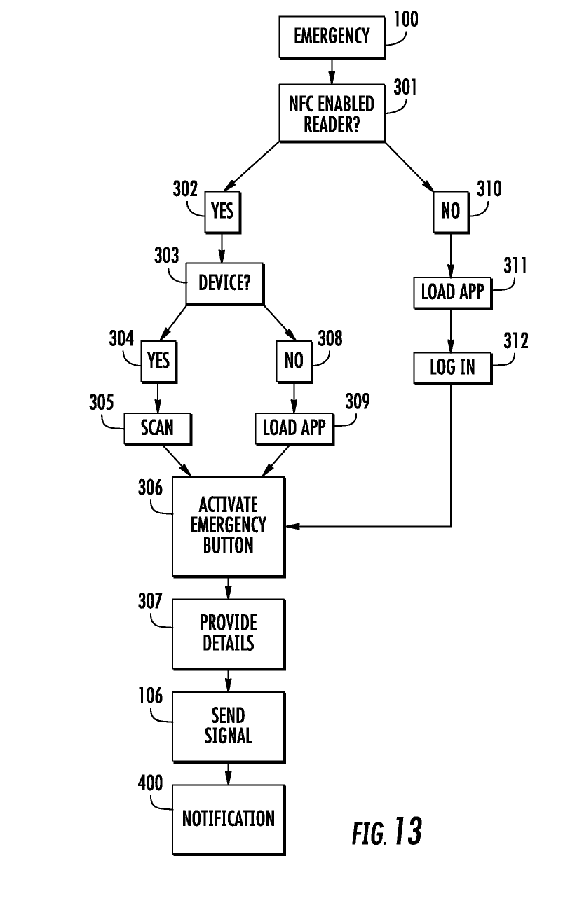

FIG. 7 illustrates a device 10 being read by a reader 40 in communication with a user interface 42 according to the invention. In this embodiment, the user interface is a computer 42 and the visual interface is 44 a monitor associated with the computer. In other embodiments, the user interface 42 could be another type of computing device including or associated with a reader, such as a hand held wireless device, such as a cellular phone 50 having wireless capabilities (“smart phone”). The device 10 is scanned, i.e., brought within sufficient proximity of the reader 40 so as to enable the reader to read the tag 36. As shown in FIG. 10, the reader 40 sends a signal 62 to a remotely located server 60 that stores the detailed patient information 46. The signal 62 contains a unique patient identifier 64. The unique patient identifier 64 may be associated with the patient identification number 26, and may optionally be a numerical code that is the same as the patient identification number 26. Each device 10 is associated with such a unique patient identifier 64, which in turn associates the card 10 with a particular set of detailed patient information 46 pertaining to the patent owner of the card. Upon receipt of the signal 62 containing the unique patient identifier 64, the server 60 identifies and retrieves the detailed patient information 46 associated with the particular patient device 10 being read, and transmits the detailed patient information 46 to the user interface 42, as shown in FIG. 10. The detailed patient information 46 is then displayed on the visual interface 44, as shown in FIG. 7. Any transmission described herein may take place using any known technologies for signal or information transmissions, including wired or wireless technologies, as shown in the illustrated embodiments.

The detailed patient information 46 includes at least some information not found printed on the device 10 itself, for example, confidential medical information that the patient would only expect to disclose to a treatment provider or a party assisting a treatment provider.

The detailed patient information 46 may include any patient information of interest to the patient, treatment providers, and individuals working with treatment providers, such as receptionists, including personal information, such as name, date of birth, social security number, contact information, emergency contact information, as well as details about the patient's medical condition and history, such as patient age, height, weight, existing medical conditions, prior conditions, surgeries, symptoms, laboratory test results, medications, prescriptions, and the names and contact information of treatment providers. The detailed patient information should not be considered limited to the information described herein, and a person of ordinary skill in the art would be capable of identifying information which may fall within the scope of the detailed patient information described herein.

The device 10 is configured to be read by the reader 40 and detailed patient information 46 displayed on a visual interface 44 to an individual of interest, such as a receptionist while checking a patient in for treatment, or to a treatment provider during treatment. This avoids the patient having to fill out paperwork and/or undergo questioning before and/or during treatment. It also ensures that the information transmitted to different parties or treatment providers is accurate and consistent, which may not be the case, for example, should a patient be required to recollect such information.

In some embodiments of the invention, login or access information may be required before the detailed patient information 46 is transmitted to the user interface 42, or after such a transmission takes place but before the detailed patient information 46 is displayed on the visual interface 44. For example, the user interface 42 may require entry of a username and/or password (“credentials”) via a patient portal application or similar portal application for use by other parties (each of which may be referred to individually as an “authorized person”), such as treatment providers. In some embodiments, the user interface 42, upon scanning the device 10, may be directed to a uniform resource identifier (URL) that requires entry of the credentials.

In some embodiments, the URL associated with a particular device 10 may be unique to a patient, for example including or being associated with the unique patient identifier 64. The URL may provide direct access to the detailed patient information 46, or may first require entry of credentials. In such an embodiment, the URL associated with each device may be configured to accept only a single set of credentials associated with the patient, or only specified sets of credentials, for example associated with the patient and the patient's treatment providers.

In some embodiments, the patient may log into a user interface 42 without the device 10 being read, for example, by manually entering a URL associated with the device and inputting credentials in order to log in and view the detailed patient information 46.

In some embodiments, an authorized person may update and add to the detailed patient information 46 while logged in. For example, the patient may provide updates concerning conditions, symptoms, compliance with treatment provider instructions, etc. A treatment provider may update the detailed patient information 46 with new information obtained during an examination, via laboratory test results, etc.

In some embodiments of the invention, the patient or other authorized person may give third parties access to the detailed patient information 46 by requesting credentials for the third party, such as a family member, which may be permanent or temporary credentials, having a set expiration or terminable upon the authorized person's request. For example, the patient may login by scanning the device, manually entering a URL, conducting a telephone or interactive voice response (IVR) conversation, and requesting a set of credentials for the third party. The third party can then utilize the device 10 or login to the patient portal application by manually entering a URL and using the third party credentials. The third party credentials may give the third party full access or partial access to a subset of the detailed patient information, at the request of the patient or other authorized person. In some embodiments the patient or other authorized person requesting generation of third party credentials may provide contact information such as an email address or telephone number for the third party, and may request that the third party credentials be transmitted to the third party by email, phone, or SMS messaging.

A process of accessing detailed patient information is illustrated in FIG. 14. In step 500 a determination is first made as to whether the device 10 is available for scanning. If the device is available found available in step 501, it is scanned using the reader 40 in step 502. The user interface 42 is then directed to the URL in step 503 and prompted to enter login credentials in step 504. If the login credentials are correctly entered, a signal 62 is sent to the server 60 in step 505, as shown in FIGS. 7 and 10. If, on the other hand, following step 500, the device is found to be not available in step 506, the user manually enters the URL In step 507. The user interface 42 is then directed to the URL in step 503 and the user prompted to enter login credentials in step 504. If the login credentials are correctly entered, a signal 62 is sent to the server in step 505, as shown in FIGS. 7 and 10.

In some embodiments, the user interface 42 is directed to a URL requiring login information if the device 10 is reported lost or stolen. For example, under normal circumstances, the detailed patient information 46 could be automatically transmitted to the user interface 42 when the tag 36 is read by a reader 40, as described above, but may be set to require login information at the request of the patient or other authorized person. Upon the patient or other authorized person reporting the device 10 lost or stolen, the detailed patient information 46 stored on the server 60 is set to a “locked” mode. Upon receipt of signal 62, the patient information set to locked mode transmits a request for login information to the user interface 42. The user then enters the correct login information, which is sent to the server 60. If the login information is correct, the detailed patient information is set to “unlocked” mode and transmitted to the user interface 42 as described above. If the user enters incorrect login information, the detailed patient information 46 remains in locked mode. Such embodiments have the advantage of providing enhanced security. In such embodiments, should the device 10 be lost or stolen, unauthorized parties will not be able to access the detailed patient information without the login or access information.

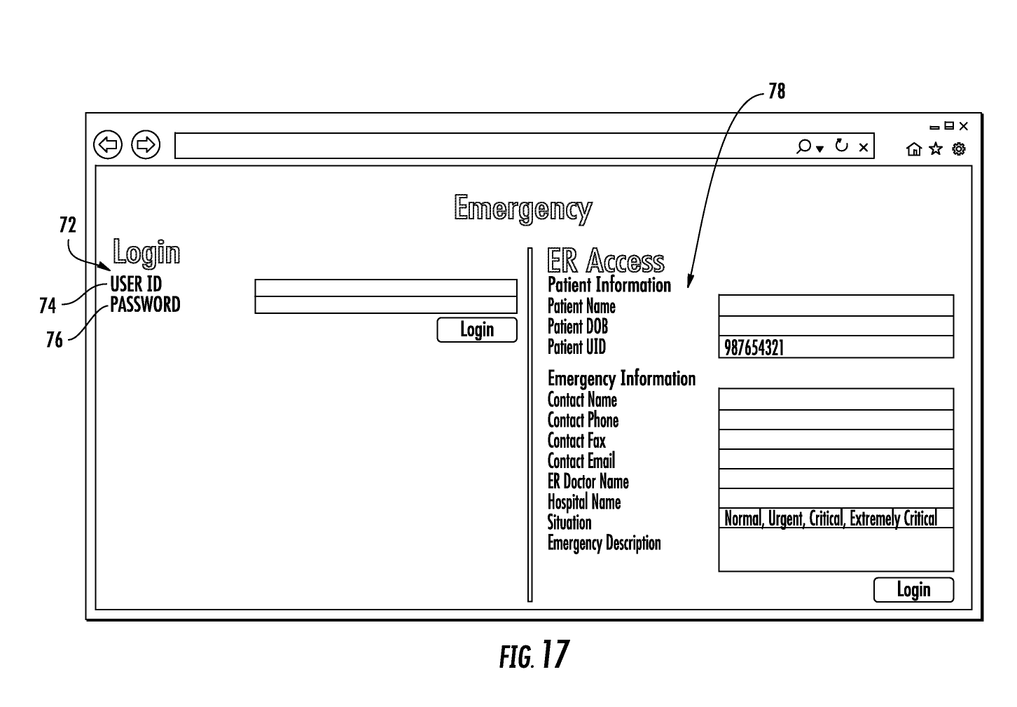

The process just described is illustrated in FIG. 15. As shown, in step 500 a determination is first made as to whether the device 10 is available. If the device is available found to be available in step 601, it is scanned using the reader 40 in step 602. The user interface 42 is then directed to the URL in step 603. A signal is sent to the server 60 to determine if the device is locked in step 604. If the device is determined to be locked in step 605, the user is prompted to enter login credentials in step 606. If the login credentials are correctly entered, a signal 62 is sent to the server 60 in step 607, as shown in FIGS. 7 and 10. If, on the other hand, following step 500, it is determined in step 608 that the device is not available, the user manually enters the URL in step 609. The user interface 42 is then directed to the URL in step 603. A signal is sent to the server 60 to determine if the device is locked in step 604. If the device is determined to be locked in step 605, the user is prompted to enter login credentials in step 606. If the login credentials are correctly entered, a signal 62 is sent to the server 60 in step 607, as shown in FIGS. 7 and 10. If, following step 604, it is determined in step 610 that the device is not locked, a signal 62 is sent to the server 60 in step 607.

In some embodiments, a device 10 may be reported lost or found by scanning the card as shown in FIG. 7 or manually entering a URL. In other embodiments, a phone number, which may optionally be an IVR enabled phone number, may be printed on the device 10 for reporting the card lost or stolen. A user, such as the patient, may call the number to report the device 10 lost or stolen and optionally set the device 10 to locked mode. An individual who finds the device 10 may then call the number to report the device 10 found and optionally receive instructions for returning the device 10.

As shown in FIG. 16, in some embodiments of the invention, various types of authorized persons may be provided with different login credentials having different levels of authorization. For example, each authorized person associated with a device 10 may have a unique user identifier and associated login credentials. Each set of login credentials may include an identifier of the authorized person's role, such as patient, receptionist, treatment provider, etc. FIG. 16 illustrates a process of transmitting a subset of detailed patient information specific to a type of authorized person. In step 700, the device 10 is scanned or URL manually entered into a user interface 42. Login credentials are then requested in step 701. Credentials that identify a user as a receptionist may have a first level of authorization. Upon logging in with the credentials identifying the user as a receptionist in step 702, a first subset of the detailed patient information 46 may be transmitted to the user interface 42 in step 703, which may include, for example, the most basic patient information, which would normally be requested upon checking in a patient for treatment. Credentials that identify a user as a treatment provider may have a second level of authorization. Upon logging in with the credentials identifying the user as a treatment provider in step 704, a second subset of the detailed patient information 46 may be transmitted to the user interface 42 in step 705, which may include, for example, more or more detailed information than the first subset, such as information that would normally be requested during treatment. Credentials that identify a user as a patient may have a third level of authorization. Upon logging in with the credentials identifying the user as a patient in step 706, a third subset of the detailed patient information 46 may be transmitted to the user interface 42 in step 707, which may include, for example, information that may be of use to the patient, such as prescriptions, treatment instructions and appointment times. Optionally, the third subset may include all of the detailed patient information 46. Any number of subsets of the detailed patient information may be created in this manner, the information in any particular subset being selected based on the type of user to whom it will be accessible.

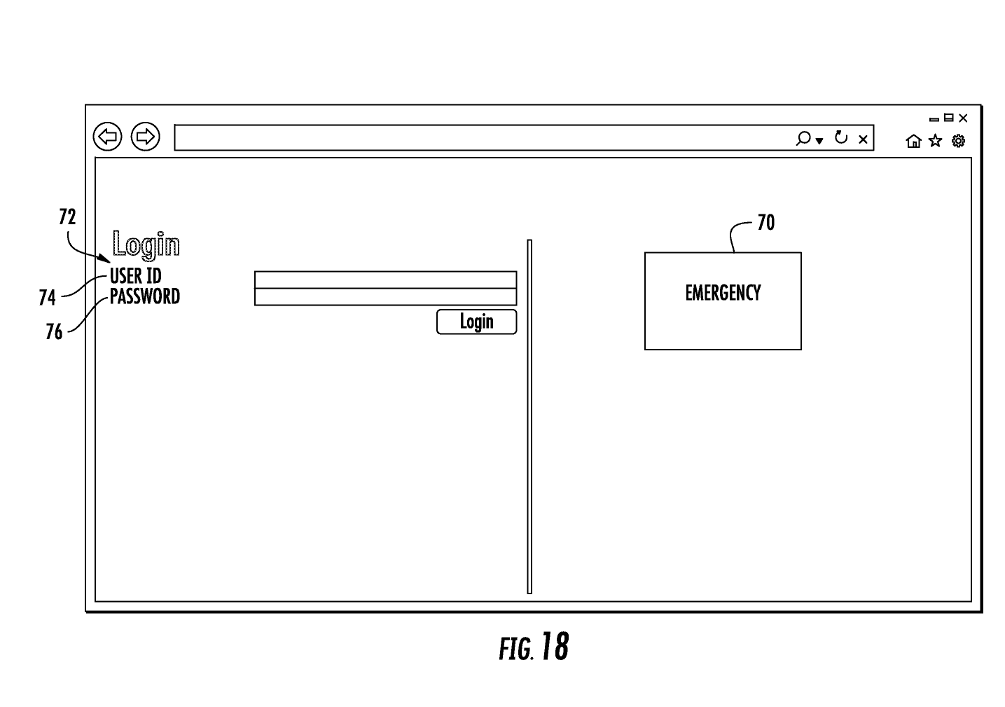

In some embodiments, a fourth subset of the detailed patient information may be designated as emergency information, and may be any information that may be helpful in an emergency situation, such as blood type, age, and physician's contact information. Emergency information may optionally be available without providing login credentials, so as to permit bystanders and treatment providers unknown to the patient to access potentially life-saving information. In one embodiment, an emergency button 70 appears on the visual interface 44 when the device 10 is read by a reader 40 as shown in FIG. 18. In embodiments requiring login credentials, the emergency button 70 may appear on the visual interface 44 along with the request for login credentials. Should a user activate the emergency button in step 708 of FIG. 16, the login request is bypassed, and the fourth subset of detailed patient information transmitted to the visual interface 44 in step 709.

In some embodiments, the emergency button 70 may activate a live voice or text chat with emergency personnel via the user interface 42. In the case of a voice chat, the user interface 42 may be IVR enabled. In yet other embodiments, an emergency may be reported via telephone. In yet other embodiments, the patient may login through the user interface 42 without scanning the device 10, by manually entering a URL associated with the device 10 and login information as described above.

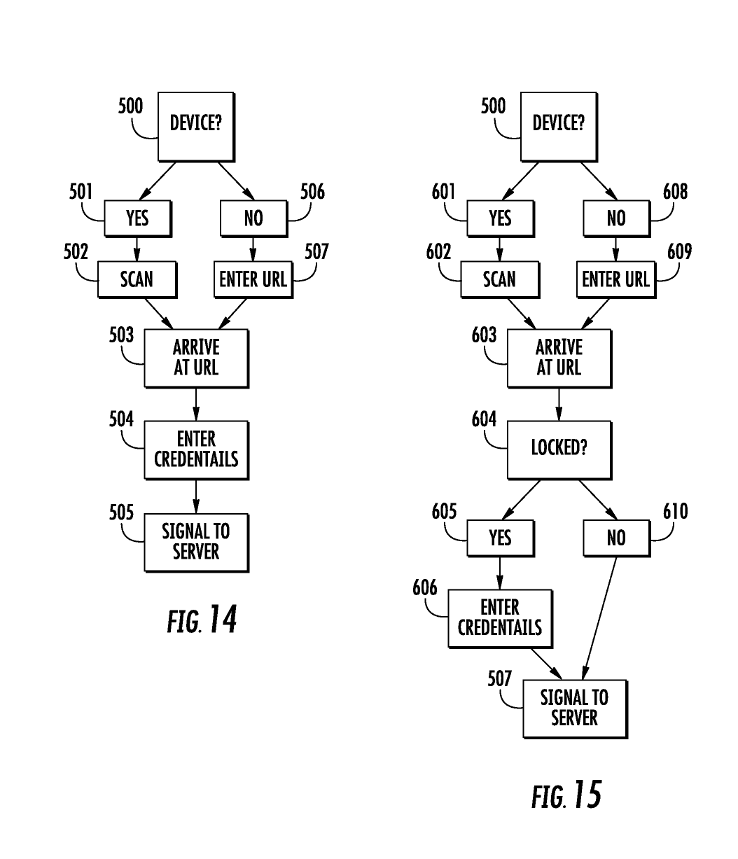

FIG. 11 is a flow chart illustrating a process that may be initiated when reporting an emergency via phone or an IVR enabled user interface 42. In this embodiment, the device 10 includes a patient identification number 26 that associates the device 10 with the patient. The patient identification number 26 may be printed on the device, as shown in FIG. 1, though this is not necessary. As shown, in step 100, an emergency occurs. In step 101, the emergency is reported. The emergency is reported by a caller who may be the patient, another authorized party, or another individual (each referred to as a “caller”). The emergency may be reported by telephone or by an IVR enabled user interface. In step 102, the caller is asked if the patient's device 10 is available. If the caller responds that the device is not available, as shown in step 103, the caller is given the option of speaking with an administrator in step 104 or leaving a message in step 105. If the caller opts to speak with an administrator in step 104, a one time access code (“OTAC”) is issued by the administrator to the caller in step 109. The OTAC may be provided immediately by the administrator, or transmitted by another secure connection such as SMS or email. The caller can use OTAC to request detailed patient information 46 in step 110. Whether the caller opts to speak with an administrator in step 104 or leave a message in step 105, an emergency signal is sent to the server 60 in step 106. In response, the server sends out at least one notification to a treatment provider in step 400. If, in step 102 it is determined that the patient's device is available in step 107, the caller is asked to provide the patient identification number 26 in step 108. A signal is sent to the server 60 in step 106, as described above, the signal including the patient identification number 26. In response, the server sends out at least one notification to a treatment provider associated with the patient identification number 26 in step 400.

FIG. 12 is a flow chart illustrating the process that may be initiated by reporting an emergency via a non IVR enabled user interface 42, wherein the device 10 is available. As shown, in step 100, an emergency occurs. In step 201 the determination is made whether the user interface 42 includes a reader 40. If the answer is yes, as shown in step 202, the device is scanned using the reader 40 in step 203. The patient is then identified and the detailed patient information 46 displayed on the visual interface 44 in step 204, which takes place according to the processes shown in FIGS. 7 and 10. The emergency button 70 appears and is activated in step 205. The user interface 42 then enables the patient or other party reporting the emergency to provide details concerning the emergency in step 206. A signal 106 is sent to the server 60, as described above, the signal including the patient identification number 26. In response, the server sends out at least one notification to a treatment provider associated with the patient identification number 26 in step 400. If the user interface 42 does not include a reader 40, as shown in step 207, the URL associated with the device 10 is entered manually in step 208. The emergency button 70 appears and is activated in step 209. The party reporting the emergency is then prompted to manually enter the patient identification number 26, which is entered in step 210. A signal is sent to the server 60 in step 106, as described above, the signal including the patient identification number 26. In response, the server sends out at least one notification to a treatment provider associated with the patient identification number 26 in step 400.

As with the other embodiments described above, in an emergency situation, detailed patient information 46 may be requested in the manners described above, for example by scanning the device using any user interface 42 according to the invention, conducting a phone call via IVR or manually entering a URL.

In some embodiments, a treatment provider who is not an authorized person, such as an emergency room (“ER”) doctor, may access detailed patient information 46 and/or send an alert to an authorized person, such as the patient's primary physician, by activating an emergency option. Such may be useful in emergency situations where non-authorized persons have an immediate need for detailed patient information 46 and/or contact with authorized treatment providers. For example, the treatment provider may log into a user interface 42 by scanning the patient's device 10 or manually entering a URL. In either event, the visual interface 44 displays a request for information having an appearance similar to that shown in FIG. 17. As shown, on the left side of the screen a request 72 for login credentials in provided, which includes a user identification request 74 and a password request 76. On the right side of the screen, an emergency access request 78 is provided, giving the user option to bypass entry of login credentials by entering basic personal information that can be obtained from the patient, such as patient's full name, date of birth, patient identification number, ER doctor name, ER hospital name, ER location details, contact person phone, and situation (i.e. normal, urgent, critical, extremely critical).

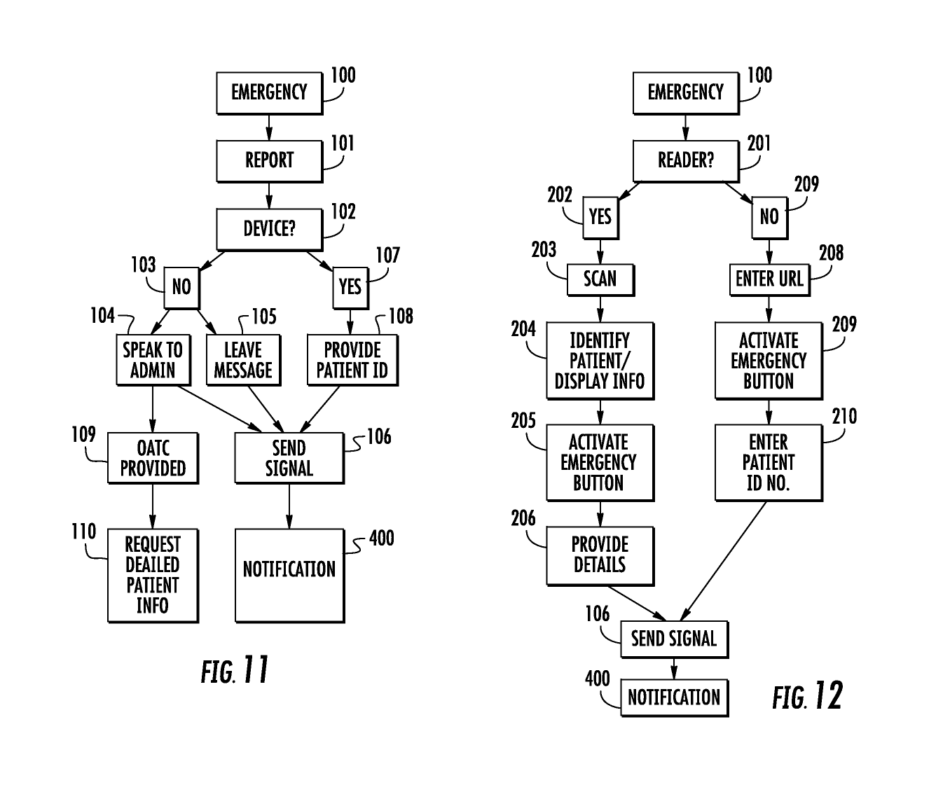

FIG. 8 shows an embodiment in which the user interface 42 is a hand held wireless device such as a smart phone 50. The visual interface 44 is formed on the user interface 42 as a phone display 52. The reader 40 is comprised within the hand held device or smart phone. Such cellular phones are known in the art, i.e., NFC enabled smart phones. In such an embodiment, the device 10 is brought within proximity of the phone 50, enabling the reader 40 to read the tag 36. The detailed patient information 46 or subset thereof is then displayed on the phone display screen 52 after entering login credentials. Such an embodiment may be particularly useful for displaying the third subset of detailed patient information to the patient, for example, to facilitate the patient checking statuses of appointments, lab results, and reading treatment provider instructions. In another embodiment, such a handheld user interface 42 may be utilized by a treatment provider during treatment. This embodiment permits treatment providers to carry a user interface 42 around from patient to patient, scanning each patient's card to retrieve the detailed patient information 46 associated with that particular patient.

FIG. 9 shows another embodiment, similar to that of FIG. 8, with the exception that user interface 42 is a non NFC enabled smart phone, which includes a camera 54. In such an embodiment, the camera 52 can be used to capture an image of the tag 36, which may be, for example a QR code. The tag image is transmitted wirelessly to a remotely located reader 40, which reads the image, enabling the detailed patient information 46 or subset thereof to be displayed on the phone display screen 52.

In some embodiments, the user interface 42 may have a preinstalled application that initiates the process described and shown in FIG. 12, for example where the user interface 42 is a smart phone or computer that belongs to the patient.

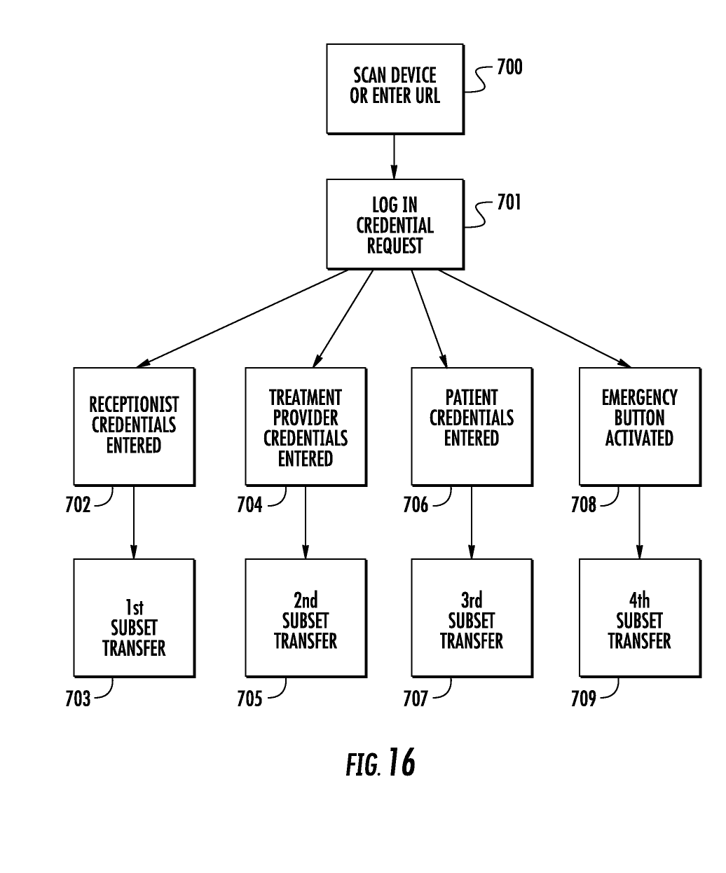

FIG. 13 is a flow chart illustrating the process that may be initiated by reporting an emergency via a handheld user interface 50, such as a smart phone. An application through which the patient may access detailed patient information 46 and report emergencies via the device 10 is loaded onto the handheld user interface 50. As shown, in step 100, an emergency occurs. In step 301 the determination is made as to whether the handheld user interface 50 is NFC enabled. If the answer is determined to be yes, in step 302, the determination is then made as to whether the device 10 is available in step 303. If the answer is determined to be yes, in step 304, the device 10 is scanned using the reader 40 in step 305. The emergency button 70 then appears and is activated in step 306. The handheld user interface 50 then enables the patient or other party reporting the emergency to provide details concerning the emergency in step 307. A signal is sent to the server 60, as described above, the signal including the patient identification number 26, in step 106. In response, the server sends out at least one notification to a treatment provider associated with the patient identification number 26 in step 400. If, on the other hand after step 303 it is determined that the device 10 is not available in step 308, the application is then manually loaded in step 309. The emergency button 70 then appears and is activated in step 306. The handheld user interface 50 then enables the patient or other party reporting the emergency to provide details concerning the emergency in step 307. A signal 106 is sent to the server 60, as described above, the signal including the patient identification number 26, in step 308. In response, the server sends out at least one notification to a treatment provider associated with the patient identification number 26, in step 400. If, after step 301 it is determined that the handheld user interface 50 is a non NFC enabled device in step 310, the application is manually loaded in step 311. A request is made for login credentials, which are provided in step 312. The emergency button 70 then appears and is activated in step 306. The handheld user interface 50 then enables the patient or other party reporting the emergency to provide details concerning the emergency in step 307. A signal 106 is sent to the server 60, as described above, the signal including the patient identification number 26, in step 308. In response, the server sends out at least one notification to a treatment provider associated with the patient identification number 26 in step 400.

In some embodiments, additional patient information that may be useful in an emergency situation may be printed on the card itself. For example, the card may list any serious health conditions of the patient, to help caregivers to identify problems and act accordingly in an emergency situation. The processes described above and shown in FIGS. 11 and 12 may be carried out by the patient himself, for example where the patient is alone, as well as by third parties, for example where the patient is in the presence of others and possibly unable to carry out the process, for example due to being unconscious.

In other embodiments of the invention, individuals other than patients may each have an associated device 10. Each such individual has an individual identification number, similar to the patient identification number 26 described above. Such individuals may include treatment providers and receptionists, and their associated devices function in the same manner as the devices described above, except rather than providing detailed patient information 46, such devices provide information of interest to the associated party. For example, a receptionist or treatment provider may have an associated device 10 which, when scanned using a reader 40 as described above, results in a display of scheduling information.

In some embodiments of the invention, user interfaces 42 may be provided for patients to use at treatment facilities, for example in kiosks or at entrances to treatment facilities. Such readers may enable patients to check in for their appointment and/or conveniently access detailed patient information that may be of use at or just prior to the time of treatment, such as reports, scheduled appointments and medication dosages. In one example, a patient may utilize such a user interface 42 to read the patient's device and access information that would normally be retrieved from a receptionist just prior to the appointment, such as a treatment room, anticipated wait time and the like.

In some embodiments, an application may be installed on the patient's smart phone or other handheld wireless device that allows the patient to remotely check-in for appointments using the device 10. For example, the patient may scan the device 10 using the smart phone 50 as a user interface 42, and remotely check-in for an approaching appointment. The smart phone 50 may then notify the treatment provider that the patient has checked in. In some embodiments the application may be capable of tracking the location of the smart phone 50, and optionally may only permit the patient to check-in in this manner where the device is detected as being within a specified geographic radius of the treatment provider.

In some embodiments, an application may be installed on the patient's smart phone or other handheld wireless device that provides the patient with notifications after checking in or otherwise using a treatment facility user interface as described above. In other embodiments, short messaging service (SMS) messages containing such notifications may be sent to patients not having smart phones or the appropriate applications installed thereon.

In some embodiments, the detailed patient information 46 may include a record of occurrences associated with the patient or the device 10. For example, the device 10 may be scanned multiple times during an appointment, such as at the reception desk, by a nurse while obtaining vital signs, by a doctor, and by laboratory officials during testing procedures. A record of each of the scans may be utilized to track patient progress through an appointment, to locate that patient, or to ensure that all procedures associated with an appointment have been performed. The device 10 may also optionally be used in this manner to determine the amount of time the patient has spent during each stage of an appointment, such as time waiting in the lobby, or time spent with a physician.

In some embodiments, detailed patient information 46 may be transmitted via any known type of secure connection, such as SMS, phone or email to treatment providers, such as in an emergency situation. In some embodiments, the location of the device 10 and/or patient may be transmitted using such a secure connection, for example, in an emergency situation, permitting such treatment providers to contact the patient.

In some embodiments, a device 10 according to the invention may also serve as an insurance or payment card, particularly in embodiments in which the device 10 is in the form of a card, and information such as treatment details or payments can be accessed by scanning the card and transmitted to the user via phone, SMS or email.

While the preferred embodiments of the invention have been described in detail above, the invention is not limited to the specific embodiments described, which should be considered as merely exemplary.

What is claimed is:

1. A portable device for retrieving medical information pertaining to a selected patient, the device comprising a tag configured to be read by at least one reader associated with a user interface, wherein the user interface is configured to display the medical information upon the reader reading the tag.

2. The device of claim 1, wherein the device is a card.

3. The device of claim 1, wherein the tag is a near field communication tag and the reader is a near field communication tag reader.

4. The device of claim 1, wherein the user interface is a computer.

5. The device of claim 1, wherein the user interface is a hand held wireless device.

6. An assembly for retrieving medical information pertaining to a selected patient, comprising:
a portable device comprising a readable tag;
a reader configured to read the tag;
a user interface in communication with the reader, the user interface comprising a visual interface configured to display the medical information upon the reader reading the tag.

7. The assembly of claim 6, wherein the user interface is a computer and the visual interface is a monitor.

8. The assembly of claim 6, wherein the medical information is stored on a remotely located server.

9. The assembly of claim 6, wherein the tag is a near field communication tag and the reader is a near field communication reader.

10. The assembly of claim 6, wherein the tag is a quick response tag and the reader is a quick response reader.

11. The assembly of claim 10, wherein:
the user interface is a hand held wireless device comprising a camera configured to capture an image of the tag; and
the reader is configured to read the image of the tag.

12. A method for retrieving medical information pertaining to a selected patient, comprising:
providing at a device associated with the patient, the device comprising a readable tag;
providing a reader configured to read the tag;
providing a user interface associated with the reader, the user interface including a visual interface and being configured to transmit a signal to a remote server that stores the medical information;
reading the tag with the reader;
transmitting the signal from the user interface to the remote server in response to reading the tag, the signal comprising a request for the medical information;
receiving the signal by the server;
transmitting the medical information from the server to the user interface in response to the signal; and
displaying the medical information on the visual interface.

13. The method of claim 12, wherein the user interface is a computer and the visual interface is a monitor.

14. The method of claim 12, wherein the user interface is a hand held wireless device.

15. The method of claim 12, further comprising:
providing a request for login credentials after reading the tag with the reader; and
receiving login credentials from a user prior to displaying the medical information on the visual interface.

16. The method of claim 12, further comprising:
providing a first option and a second option after reading the tag with the reader, wherein the first option comprises a user entering login credentials, and the second option comprises the user activating an emergency option.

17. The method of claim 16, wherein the emergency option comprises at least one of a user activating an emergency button or a user complying with an information request.

18. The method of claim 8, wherein the emergency option comprises a user activating an emergency button, wherein the emergency button is displayed on the user interface.

19. The method of claim 16, further comprising selecting the second option, wherein the method further comprises initiating contact between a user and emergency personnel after selecting the second option.

20. The method of claim 17, wherein the information request comprises a request for personal information pertaining to the patient.
